(19) United States
(12) Patent Application Publication
(10) Pub. No.: US 2012/0191790 A1
(43) Pub. Date: Jul. 26, 2012

(54) Web-Based Push Messaging Methods and Systems

(75) Inventors: Essam Ernest Abadir, Lancaster, PA (US); Rosco Schock, Lancaster, PA (US)

(73) Assignee: appMobi, Inc., Lancaster, PA (US)

(21) Appl. No.: 13/356,412

(22) Filed: Jan. 23, 2012

Related U.S. Application Data
(60) Provisional application No. 61/435,470, filed on Jan. 24, 2011.
(60) Provisional application No. 61/558,896, filed on Nov. 11, 2011.

(51) Int. Cl. G06F 15/16

(52) U.S. Cl. 709/206

(57) ABSTRACT

A system capable of coordinating push messages from among a plurality of sources is disclosed. The system includes a push message server communicatively connected to a plurality of publishers. The push message server includes a push subscription database containing a plurality of records, each record associating a user identity with a push message publisher and a user preference for receiving push messages from the publisher. The push message server also includes a communication component configured to receive push messages from one or more of the plurality of publishers and, based on user subscriptions managed in the push subscription database, transmit the push messages to one or more subscribers.

### CROSS REFERENCE TO RELATED APPLICATIONS

The present application claims priority to U.S. Provisional Application No. 61/435,470, filed Jan. 24, 2011, and U.S. Provisional Patent Application No. 61/558,896, filed Nov. 11, 2011, the disclosures of which are hereby incorporated by reference in their entireties.

### TECHNICAL FIELD

The present application generally relates to web-based data distribution, and in particular to a web-based push messaging system, and methods of operation and use.

### BACKGROUND

Today, “Push Messages” can be sent to a mobile device with either a messaging-specific application (e.g., Microsoft Outlook, or instant messaging applications) or using traditional text messages (i.e., SMS or MMS) sent to a defined phone number. A “Push Message” refers to a message sent from a server to an application on a device, and can be received by the user of a device even when the application is not running or has not specifically transmitted a request to that server for the message.

Current push messaging systems have drawbacks. For example, a sender of a push message must know the contact information of each user or users to whom the message is to be sent. Additionally, such systems are generally organized to allow for push messages to be sent to a relatively narrow audience of recipients, and therefore such systems are not designed to be suitable for wider distribution.

For these and other reasons, improvements are desirable.

### SUMMARY

In accordance with the following disclosure, the above and other issues are addressed by the following:

In a first aspect, a system capable of coordinating push messages from among a plurality of sources is disclosed. The system includes a push message server communicatively connected to a plurality of publishers. The push message server includes a push subscription database containing a plurality of records, each record associating a user identity with a push message publisher and a user preference for receiving push messages from the publisher. The push message server also includes a communication component configured to receive push messages from one or more of the plurality of publishers and, based on user subscriptions managed in the push subscription database, transmit the push messages to one or more subscribers.

In a second aspect, a method of distributing push messages to one or more users includes receiving at a push message server a push message and an identity of one or more intended recipients from a publisher, and checking the identity against a list of subscribed users to determine a list of one or more recipients of the push message. The method also includes queuing the message for transmission to each of the one or more recipients.

In a third aspect, a method of sending push messages includes receiving an indication from a user device at a publisher indicating an intent to subscribe to push messages associated with the publisher, and transmitting a subscription request to a push message server, the subscription request including information identifying the user, the publisher, and an intent to subscribe to push messages associated with the publisher. The method also includes transmitting a push message to the push message server alongside an identity of the user, thereby causing the push message server to transmit a push message to a push-enabled web browser of a user device.

In a fourth aspect, a method of receiving push messages includes installing a push-enabled web browser at a mobile device and visiting a web domain of a publisher. The method also includes taking one or more actions indicating a desire to subscribe to push messages associated with the publisher. The method further includes, at a later time, and after one or more push messages is transmitted from the publisher to a push message server, receiving a push message from the push message server that is originated from the publisher without transmitting a request to the push message server.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

FIG. 1 is a system diagram of one embodiment of an environment in which aspects of the present disclosure may be practiced.

FIG. 2 is a schematic diagram of a push message server, according to an example embodiment.

FIG. 3 is a schematic diagram of a sample user interface including a push enabled web browser on a mobile device.

FIG. 4 is a schematic diagram of a sample user interface of a push enabled web browser on a mobile device.

FIG. 5 is a flowchart illustrating a method of receiving push messages at a push enabled web browser, according to an example embodiment.

FIG. 6 is a flowchart illustrating a method of subscribing a user for push messages at a publisher, according to an example embodiment.

FIG. 7 is a flowchart illustrating a method of managing push messages at a push message server, according to an example embodiment.

FIG. 8 is a flowchart illustrating a method of delivering push messages from a push message server to a push-enabled web browser, according to an example embodiment.

FIG. 9 is a simplified block diagram of a computing device with which embodiments of the present invention may be practiced.

FIGS. 10A and 10B are simplified block diagrams of a mobile computing device with which embodiments of the present invention may be practiced.

FIG. 11 is a simplified block diagram of a distributed computing system in which embodiments of the present invention may be practiced.

### DETAILED DESCRIPTION

Example embodiments of the present disclosure now will be described with reference to the accompanying drawings, which form a part hereof, and which show, by way of illustration, specific embodiments by which the systems described herein may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. For instance, the systems and methods of the present disclosure may take the form of an entirely software embodiment or an embodiment combining software and hardware aspects. The following detailed description is, therefore, not to be taken in a limiting sense.

In addition, the logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler. As described below, various embodiments of the present disclosure may be readily combined, without departing from the scope or spirit of the invention. Throughout this disclosure, the following terms take the meanings explicitly associated herein, unless the context clearly dictates otherwise.

In general the present disclosure relates to web-based push messaging systems, and methods of operation and use. Generally, push messaging corresponds to delivery of push messages to a remote device, such as a mobile device. A “push message” refers to a message sent from a server to an application on a device, and can be received by the user of a device even when the application is not running or has not specifically transmitted a request to that server for the message.

Briefly stated, the present disclosure relates to a system of sending push messages from potentially a variety of different web site publishers to many different users of mobile devices. In accordance with the following disclosure, push messages can be transmitted to a broad, selectable audience of users whose contact information and preferences relating to receipt of such push messages can be managed using a push message server. By centralizing push message distribution, user preferences relating to receipt of push messages can be controlled easily, as well as management of methods for contacting a user device on which a compatible push messaging application is installed.

The present disclosure also involves, in some aspects, use of a push-enabled web browser (“PEWB”). In accordance with the present disclosure, a PEWB can include a web browser that can receive push messages on behalf of multiple web sites.

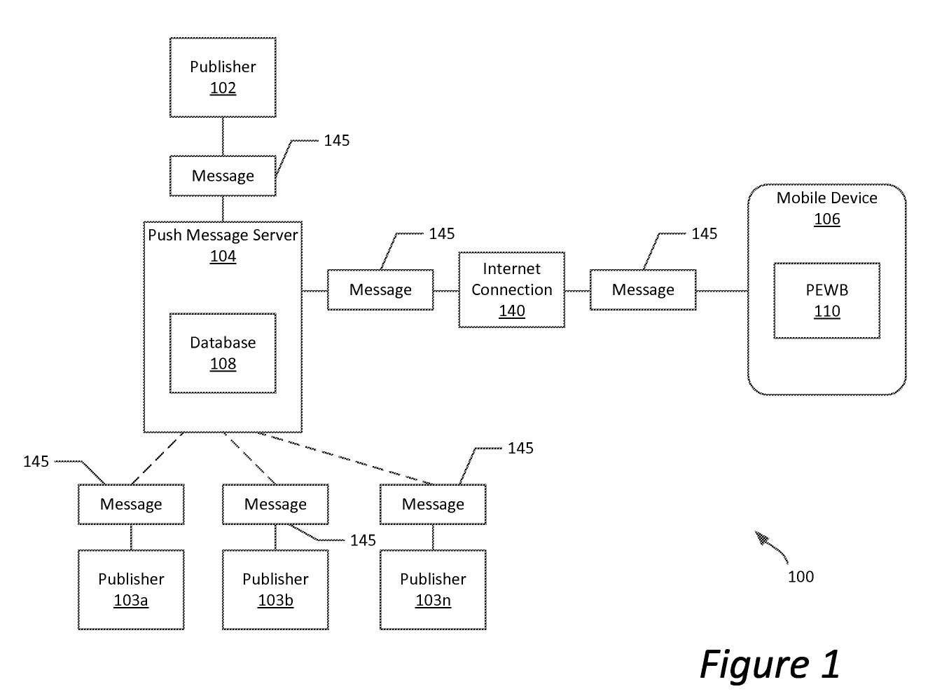

Referring now to FIG. 1, a system diagram is illustrated, including an example embodiment of an environment 100 in which aspects of the disclosure may be practiced. Not all the steps, features, or entities in the diagram may be required, and variations in the arrangement and type of the features illustrated may be made without departing from the spirit or scope of the present disclosure.

In the embodiment shown, the environment includes a publisher 102 communicatively connected to a push message server 104. In various embodiments, the publisher 102 could be any company, government or non-profit entity, individual, or other organization. The publisher 102 wishes to create and send push messages to users on their mobile devices, such as mobile device 106.

The environment 100 as shown also depicts a plurality of additional publishers 103a-n. Any number of these additional publishers 103a-n can also be communicatively connected to the push message server 104, and can use the system of present disclosure to send push messages to users. As is well known in the art, push messages can be used for almost any purpose.

The push message server 104 is generally a server managed by either a publisher or a third party, and is configured to manage distribution of push messages to one or more users at supported devices, such as mobile device 106. The push message server 104 includes a database 108 configured to aggregate and maintain data relating to user preferences for receiving push messages from the publisher 102, and optionally other publishers 103a-n. In some embodiments, the push message server 104 is managed by the publisher 102; in other embodiments, (such as that shown) the push message server 104 is not affiliated with any one particular publisher, and instead represents a central repository and clearinghouse for push message settings, providing a simple interface for publishers to access to distribute push messages to users.

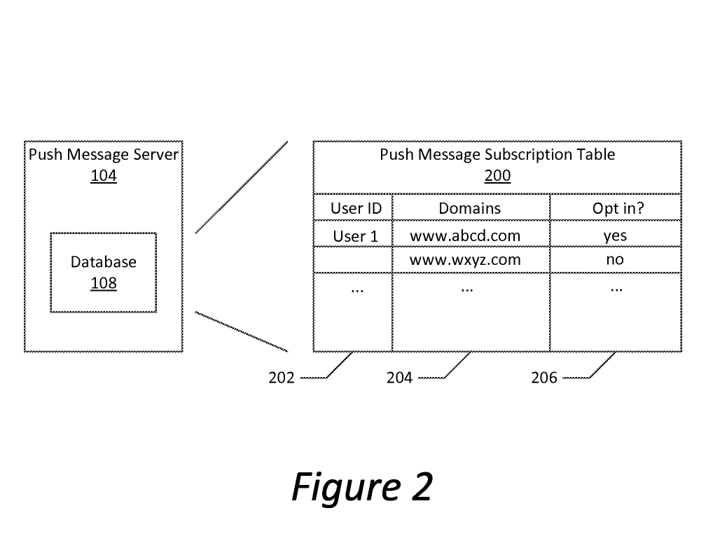

The database 108 can contain a variety of types of information used for distribution of push messages. One example illustrating some of the information contained within database 108 is discussed below, and illustrated in FIG. 2.

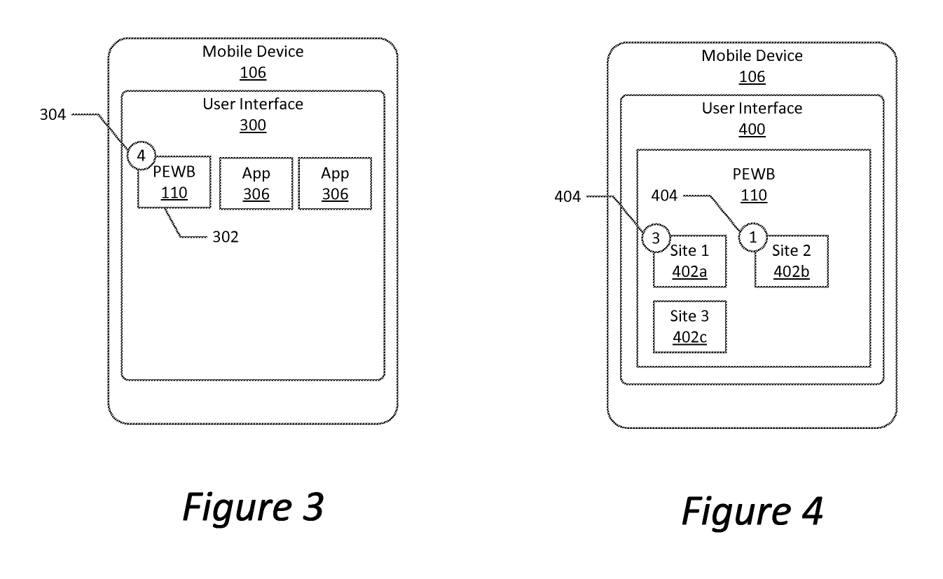

In the embodiment shown, the mobile device 106 includes a push-enabled web browser 110 installed thereon. The mobile device can be any of a variety of devices, such as a mobile computing device, Generally, a supported device corresponds to a device having installed thereon a push-enabled web browser (“PEWB”). The PEWB 110 can be, in some embodiments, downloadable and capable of installation on the mobile device 106 as an application. Details of such an example PEWB are discussed below and illustrated in FIGS. 3-4.

In the embodiment shown, the mobile device 106 and associated PEWB 110 is accessed by a user. When the PEWB 110 is first run by the user of Mobile Device 106, codes uniquely identifying the device and the user of the PEWB are sent to the push message server 104 for storage in database 108. These codes will be used later if a publisher web site wishes to send a push message through the backend server to the PEWB 110 on that particular device 106.

When a user visits a web site using the PEWB 110 on the device 106, the PEWB 110 may prompt the user to “opt-in” to receive push messages from the web site. Alternatively, the PEWB 110 may implicitly opt the user in to receiving push messages when the user visits the web site of the publisher. Yet another alternative is that when the user “bookmarks” the web page, the PEWB 110 may implicitly opt the user in to receiving push messages from the site publisher 102. Other methods of opting in are also possible. Regardless of how it is achieved, the opt-in status of the user, relative to the site associated with the publisher 102, is transmitted to the server 104.

As illustrated in FIG. 1, one or more of the publisher 102, push message server 104, and mobile device 106 can be interconnected by a communicative connection, such as via the internet 140. Although in the drawing the push message server 104 is illustrated as a conduit of messages 145 between the publisher 102 and the mobile device 106, it is recognized that other messages can be transmitted among those devices directly.

Referring now to FIG. 2, further details regarding server 104 and associated database 108 are illustrated. In the embodiment shown, server 104 stores the opt-in status for the user in database 108 in an associative table 200 of device codes 202, web site domains or pages 204, and opt-in statuses 206. At the same time, if the user is determined to have opted-in to receiving push messages from the web site, the code identifying the user is transmitted to publisher web site 102 via well-known methods of data transmission over the internet. Therefore, the backend server 104 knows which users are opted-in to receive push messages from which publisher web sites.

Referring now to FIGS. 3-4, schematic illustrations of an example embodiment of a PEWB 110 operating on a mobile device 106 are shown. In FIG. 3, a first schematic illustration of a user interface 300 is provided, in which the PEWB 110 is not open or active. In contrast, in FIG. 4, a schematic illustration of user interface 400 is shown, in which the PEWB 110 is opened.

As can be seen in comparing FIGS. 3-4, even when the PEWB is not open, push messages can be received and aggregated at the mobile device 106. This can be seen, for example, with the icon 302 identifying the PEWB 110, and the associated graphical notifier 304 indicating a total number of new push messages received by the PEWB 110, which can be listed among a variety of other applications 306. In the example shown, four push messages, from various sources, have been received at the PEWB 110. However, as seen in the user interface 400 of FIG. 4, when the user opens the PEWB 110, push messages from one or more Publishers URLs or web domains 402a-c are attributed to their source, so the user can decide whether or not to view them. As seen in that figure, three sites 402a-c are present, of which two have new associated push messages (defined by indicators 404), with a first site 402a (e.g., a publisher, web domain, or page) associated with three push messages and a second site 402b associated with one push message. Accordingly, although the user does not need to open the PEWB 110 on his or her device to learn that there are four pending push messages, he or she can open the PEWB 110 to view which sources those messages relate.

In addition, the PEWB 110 can include a user interface, such as user interface 400 of FIG. 4, which includes a plurality of options or preferences regarding push messages. By editing those options or preferences the PEWB 110 can transmit an update to the server 104 to update table 200 by adding or opting out of push messages associated with a particular publisher or domain, such that the PEWB only receives the desired push messages.

Generally, in the embodiment shown, PEWB 110 can be used to browse the world wide web like any other browser, but it can also be used to display push messages, along with a summary of how many unread messages are associated with each URL or domain. PEWB 110 displays all push messages sent by the backend server to the user device 106. In some embodiments, PEWB 110 can also display the number of pending push messages in one location and can show how many push messages a user has received from all publishers in one location.

Although in the embodiments of FIGS. 1-4 push messages are discussed in the context of particular domains associated with different publishers, it is understood that, analogously, separate push message arrangements could be employed for different web pages associated with a single domain. For example a user could elect to receive push messages from a particular online news publisher, but could select among various news sections (e.g., local news, national news, sports, weather, opinion, etc.) associated with a single domain, without opting-in to all push messages from that particular publisher.

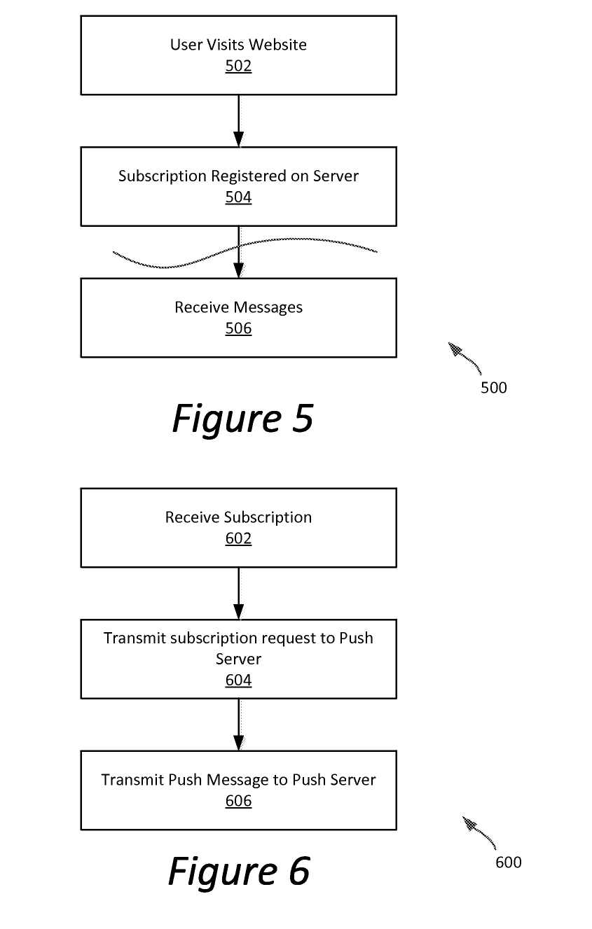

Referring now to FIGS. 5-8, methods of operation of the systems described above are discussed generally. In general, the methods of operation occur at one or more of a publisher, a push message server, or a user's mobile device, as those items are described above in connection with FIGS. 1-4.

FIG. 5 illustrates an example method 500 by which a user subscribes to push messages of one or more publishers, such as by using a user device 106 to access content of a publisher 102 as described in FIG. 1, above. The method includes visiting the website of the publisher 102, for example via an internet connection or other data connection (step 502). The method also includes registering a subscription with a push messaging server (step 504). This can be triggered, for example, based on a number of possible user actions, such as visiting a website of the publisher, bookmarking a page associated with a site of the publisher, or an explicit instruction from a user to the publisher's site to subscribe to push messages. The subscription can, in various embodiments, associate the user with the publisher generally, with a particular domain associated with the publisher, or with a particular website or group of websites associated with the publisher.

After the user is registered with the publisher 102 (or specific website or domain associated with the publisher), the user can receive one or more push messages in his or her PEWB 110, for example on the mobile device on which the subscription was made (step 506). In various embodiments, the push messages can be specific to that user or generalized push messages from a particular publisher, or from multiple publishers, via the push messaging server.

FIG. 6 illustrates an example method 600 performed at a publisher for managing and distributing push messages to users and associated mobile devices. The method 600 includes receiving subscription information regarding a particular user and/or user device at the publisher (step 602). The method also includes transmitting that subscription request information to the push message server (step 604), for example such that a push message server (e.g., server 104) can enter subscription information into a push message subscription database, such as database 108 as illustrated in FIG. 2. Once subscription information is entered at the push message server 106, the publisher can transmit one or more push messages to the push message server (step 606).

In various embodiments, the publisher can elect to transmit push messages to one or more users, or to all users who have subscribed to push messages from that publisher. Accordingly, the message transmitted from the publisher to the push message server could include either a listing of each user to whom the message is intended, or an indication that all subscribed users should receive the push message.

In certain embodiments, the publisher will not receive subscription information or transmit that information to the push message server 104, but instead that information is transmitted directly from a user device (e.g., device 106) to the push message server. Accordingly, steps 602-604 could occur on a mobile device having an associated PEWB, such as PEWB 110, installed thereon, and could occur in response to any of the above-described indications of a request to subscribe to push messages.

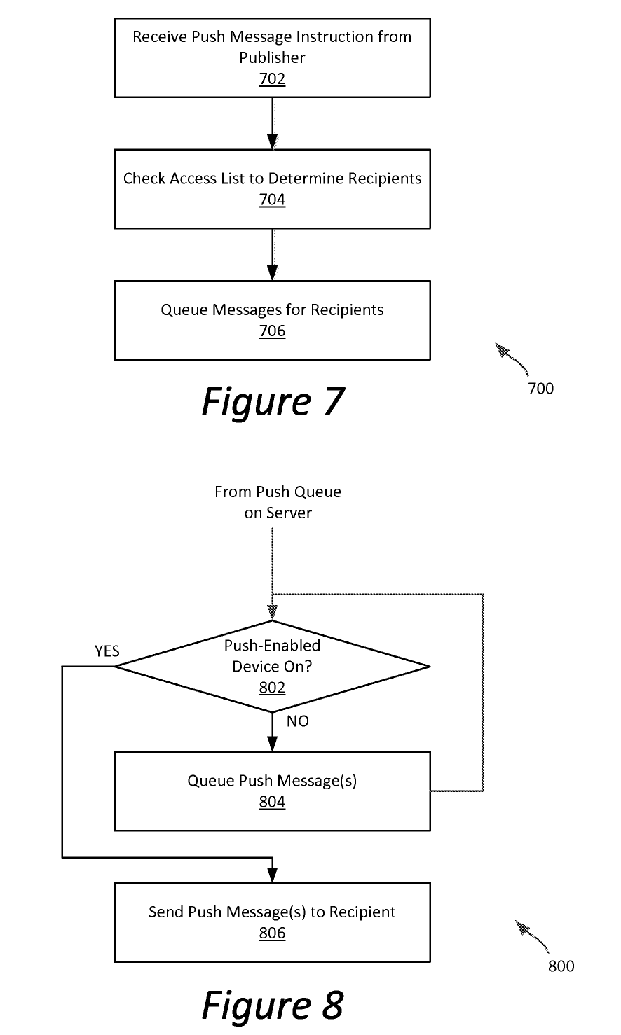

Referring now to FIG. 7, a further flowchart is depicted, which represents a method 700 for managing distribution of push messages, according to an example embodiment. The method includes receiving an instruction from a publisher, such as publisher 102, to transmit a push message to one or more user devices (step 702). The method also includes checking a database, such as database 108, to determine whether the user to whom the publisher has addressed the push message has opted to receive push messages from that publisher or associated with the particular domain or page from which the instruction originates (step 704). This can include, for example, checking a push message access list in the database against a code uniquely identifying the user that is received from the publisher. The code can be used, for example, to determine if the domain of the publisher is associated with the user, and whether the opt-in status of that domain indicates that the user has opted-in to receiving a push message from that publisher, or from that specific domain or webpage associated with the publisher. In circumstances where the publisher decides to transmit the push message to all opted-in users, the push message server 104 can collect a list of opted-in users associated with the domain of that publisher, as well as methods to contact and distribute push messages to those users.

Based on steps 702-704, the push message server 104 aggregates push messages from a variety of different publishers (e.g., publisher 102 as well as publishers 103a-n) intended to be transmitted to any users, and manages the routing to various users. In other words, regardless of which publisher originally sent the push message, the backend server next queues the push message for transmission through an Internet Connection 140 to the validated user device (e.g., device 106) (step 706).

It is seen that, in FIG. 7, although the publisher may only send a unique user code to the push message server in connection with the push message to be transmitted, the push message server will store contact information sufficient to contact the specific PEWB and associated user device. This information can be collected, for example, at the time the user device downloads the PEWB, or at the time the user opts to subscribe to the particular publishers' push messages. Accordingly, contact information for a particular mobile device 106 does not need to be stored and updated by each publisher that wishes to transmit push messages.

Referring now to FIG. 8, a flowchart is depicted illustrating an example method 800 for transmitting push messages from a push message server to a particular user device. Generally, the method 800 corresponds to a process for delivering one or more push messages, which may have originated from one or more different publishers, to a particular user device and associated PEWB, after validation of each message against a database of push message subscription information (e.g., database 108).

In the embodiment shown, the push message server determines if messages are present in a push message queue to be sent to a particular user's device. If so, the push message server attempts to connect to that device and determine if the device is on, communicatively connected (e.g., not out of range, but instead connected to the internet, via internet connection 140), and otherwise capable of receiving data (step 802). If the device is not on or otherwise available, the messages to be transmitted to that particular device are placed in a queue to be transmitted to the device at a later time (step 804), and monitoring continues until the push message server determines that the device is on and available to receive push messages (branching “NO” and returning to step 802 to reevaluate connectivity). If the push-enabled device is on and capable of receiving push messages, the push message server transmits all push messages from all publishers to that device (branching “YES” to step 806).

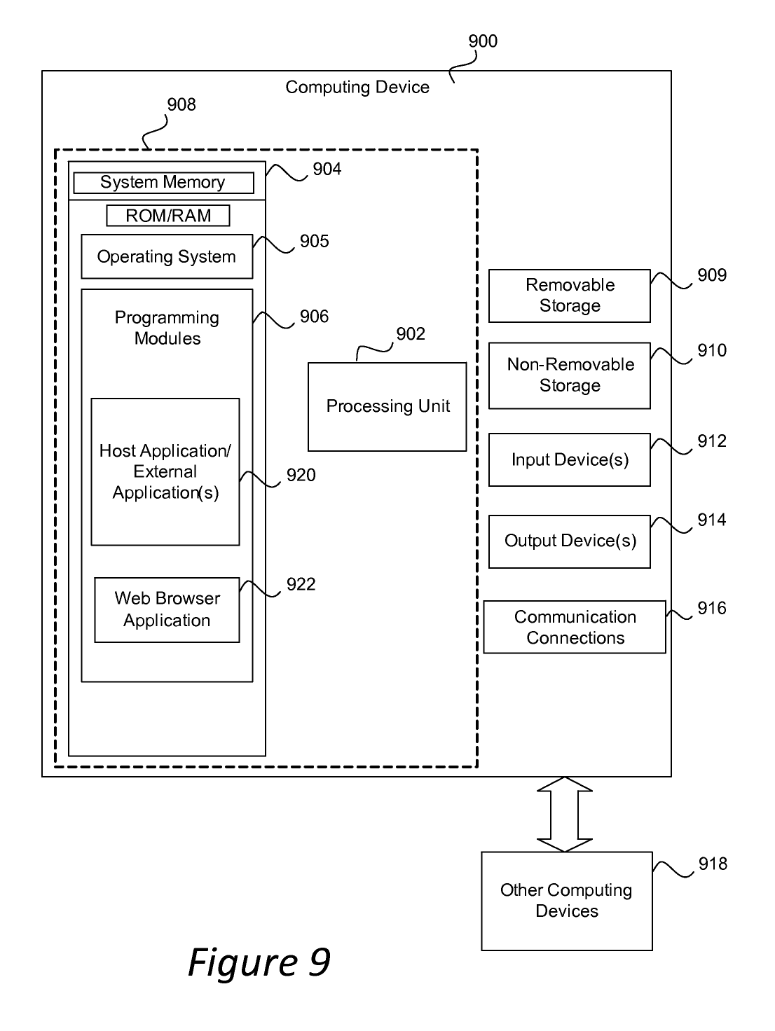

Referring now to FIGS. 9-11, various different electronic computing devices can be used to accomplish the various features discussed above, including the publishers 102, 103a-n, push message server 104, and the mobile device 106. For example, the embodiments and functionalities described herein may operate via a multitude of computing systems including wired and wireless computing systems, mobile computing systems (e.g., mobile telephones, tablet or slate type computers, laptop computers, etc.). In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 9 through 11 and the associated descriptions provide a discussion of a variety of operating environments in which embodiments of the invention may be practiced. However, the devices and systems illustrated and discussed with respect to FIGS. 9 through 11 are for purposes of example and illustration and are not limiting of a vast number of computing device configurations that may be utilized for practicing embodiments of the invention, described herein.

FIG. 9 is a block diagram illustrating example physical components of a computing device 900 with which embodiments of the invention may be practiced. The computing device components described below may be suitable for the computing devices described above, for example, the publisher 102, the push message server 104, and the mobile device 106. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905 and one or more programming modules 906, which are suitable for running applications 920 such as PEWB 110 or server applications (e.g., a service application or database management application executing on the push message server 104). Operating system 905, for example, may be suitable for controlling the operation of computing device 900. Furthermore, embodiments of the invention may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910.

As stated above, a number of program modules and data files may be stored in system memory 904, including operating system 905. While executing on processing unit 902, programming modules 906 may perform processes including, for example, one or more of the methods 500-800 described herein. The aforementioned process is an example, and processing unit 902 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality of server applications 920 or client applications 922 may be implemented via application-specific logic integrated with other components of the computing device 900 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) 914 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. Computing device 900 may include communication connections 916 allowing communications with other computing devices 918. Examples of suitable communication connections 916 include, but are not limited to, RF transmitter, receiver, and/or transceiver circuitry; universal serial bus (USB), parallel, or serial ports, and other connections appropriate for use with the applicable computer readable media.

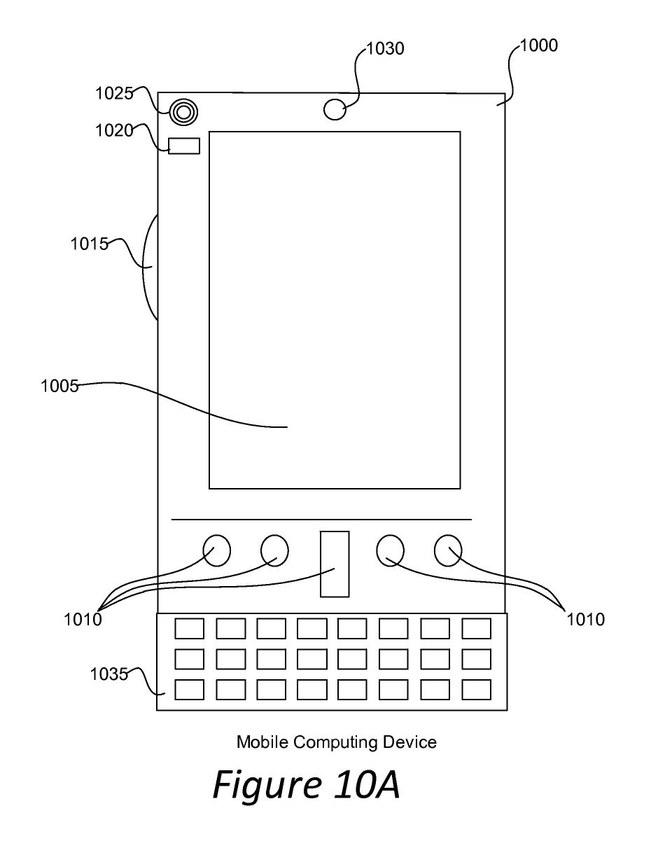

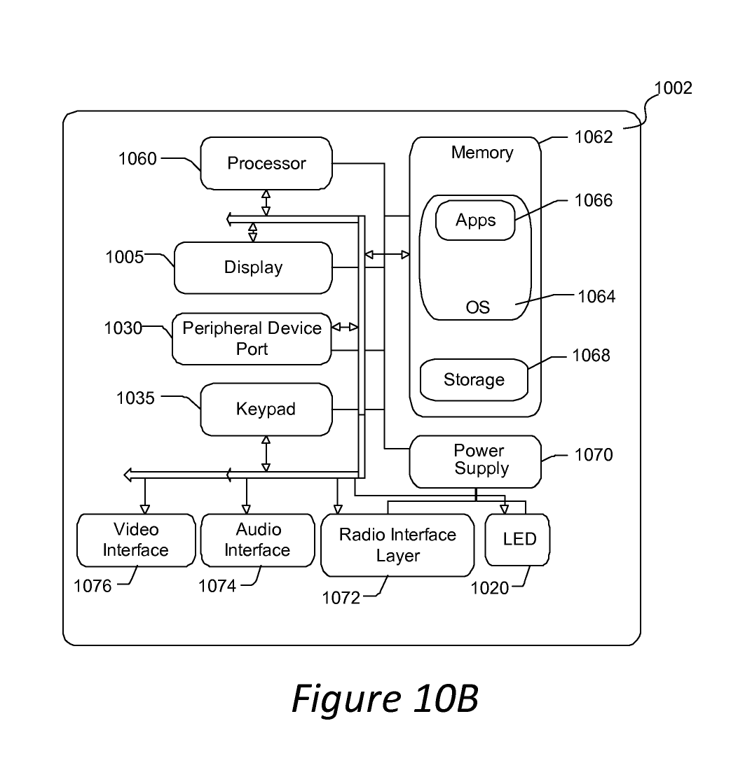

FIGS. 10A and 10B illustrate a suitable mobile computing environment, for example, a mobile telephone 1000, a smart phone, a tablet personal computer, a laptop computer, and the like, with which embodiments of the invention may be practiced. With reference to FIG. 10A, an example mobile computing device 1000 for implementing the embodiments is illustrated. In a basic configuration, mobile computing device 1000 is a handheld computer having both input elements and output elements. Input elements may include touch screen display 1005 and input buttons 1010 that allow the user to enter information into mobile computing device 1000. Mobile computing device 1000 may also incorporate an optional side input element 1015 allowing further user input. Optional side input element 1015 may be a rotary switch, a button, or any other type of manual input element. In alternative embodiments, mobile computing device 1000 may incorporate more or less input elements. For example, display 1005 may not be a touch screen in some embodiments. In yet another alternative embodiment, the mobile computing device is a portable phone system, such as a cellular phone having display 1005 and input buttons 1010. Mobile computing device 1000 may also include an optional keypad 1035. Optional keypad 1035 may be a physical keypad or a “soft” keypad generated on the touch screen display.

Mobile computing device 1000 incorporates output elements, such as display 1005, which can display a graphical user interface (GUI). Other output elements include speaker 1025 and LED light 1020. Additionally, mobile computing device 1000 may incorporate a vibration module (not shown), which causes mobile computing device 1000 to vibrate to notify the user of an event. In yet another embodiment, mobile computing device 1000 may incorporate a headphone jack (not shown) for providing another means of providing output signals.

Although described herein in combination with mobile computing device 1000, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 10B is a block diagram illustrating components of a mobile computing device used in one embodiment, such as the computing device shown in FIG. 10A. That is, mobile computing device 1000 can incorporate system 1002 to implement some embodiments. For example, system 1002 can be used in implementing a “smart phone” that can run one or more applications similar to those of a desktop or notebook computer such as, for example, browser, e-mail, scheduling, instant messaging, and media player applications. In some embodiments, system 1002 is integrated as a computing device, such as an integrated personal digital assistant (PDA) and wireless phone.

One or more application programs 1066 may be loaded into memory 1062 and run on or in association with operating system 1064. Examples of application programs include phone dialer programs, e-mail programs, personal information management (PIM) programs, word processing programs, spreadsheet programs, Internet browser programs, messaging programs, and so forth. System 1002 also includes non-volatile storage 1068 within memory 1062. Non-volatile storage 1068 may be used to store persistent information that should not be lost if system 1002 is powered down. Applications 1066 may use and store information in non-volatile storage 1068, such as e-mail or other messages used by an e-mail application, and the like. A synchronization application (not shown) also resides on system 1002 and is programmed to interact with a corresponding synchronization application resident on a host computer to keep the information stored in non-volatile storage 1068 synchronized with corresponding information stored at the host computer. As should be appreciated, other applications may be loaded into memory 1062 and run on the device 1000, including the various client and server applications described herein.

System 1002 has a power supply 1070, which may be implemented as one or more batteries. Power supply 1070 might further include an external power source, such as an AC adapter or a powered docking cradle that supplements or recharges the batteries.

System 1002 may also include a radio 1072 that performs the function of transmitting and receiving radio frequency communications. Radio 1072 facilitates wireless connectivity between system 1002 and the “outside world”, via a communications carrier or service provider. Transmissions to and from radio 1072 are conducted under control of the operating system 1064. In other words, communications received by radio 1072 may be disseminated to application programs 1066 via operating system 1064, and vice versa.

Radio 1072 allows system 1002 to communicate with other computing devices, such as over a network. Radio 1072 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1002 is shown with two types of notification output devices; light emitting diode (LED) 1020 that can be used to provide visual notifications and an audio interface 1074 that can be used with speaker 1025 to provide audio notifications. These devices may be directly coupled to power supply 1070 so that when activated, they remain on for a duration dictated by the notification mechanism even though processor 1060 and other components might shut down for conserving battery power. LED 1020 may be programmed to remain on indefinitely until the user takes action to indicate the powered-on status of the device. Audio interface 1074 is used to provide audible signals to and receive audible signals from the user. For example, in addition to being coupled to speaker 1025, audio interface 1074 may also be coupled to a microphone to receive audible input, such as to facilitate a telephone conversation. In accordance with embodiments of the present invention, the microphone 1020 may also serve as an audio sensor to facilitate control of notifications, as will be described below. System 1002 may further include video interface 1076 that enables an operation of on-board camera 1030 to record still images, video stream, and the like.

A mobile computing device implementing system 1002 may have additional features or functionality. For example, the device may also include additional data storage devices (removable and/or non-removable) such as, magnetic disks, optical disks, or tape. Such additional storage is illustrated in FIG. 10B by storage 1068. Computer storage media may include volatile and nonvolatile, removable and non-removable media implemented in any method or technology for storage of information, such as computer readable instructions, data structures, program modules, or other data.

Data/information generated or captured by the device 1000 and stored via the system 1002 may be stored locally on the device 1000, as described above, or the data may be stored on any number of storage media that may be accessed by the device via the radio 1072 or via a wired connection between the device 1000 and a separate computing device associated with the device 1000, for example, a server computer in a distributed computing network, such as the Internet. As should be appreciated such data/information may be accessed via the device 1000 via the radio 1072 or via a distributed computing network. Similarly, such data/information may be readily transferred between computing devices for storage and use according to well-known data/information transfer and storage means, including electronic mail and collaborative data/information sharing systems.

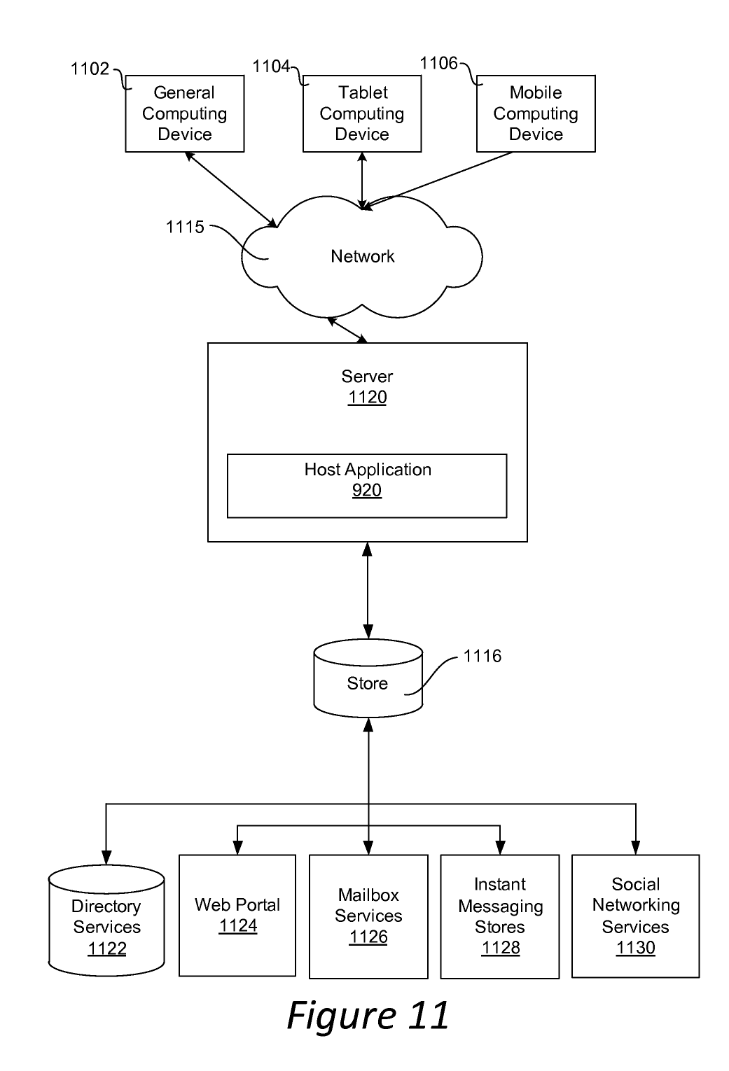

FIG. 11 illustrates a system architecture for providing data services to one or more client devices, as described above. Content developed, interacted with or edited in association with the data services may be stored in different communication channels or other storage types. For example, various documents may be stored using directory services 1122, web portals 1124, mailbox services 1126, instant messaging stores 1128 and social networking sites 1130. The push messaging server 104 or publisher 102 may use any of these types of systems or the like for enabling data utilization, as described herein. A server 1120 may provide the host application 320 to clients. As one example, server 1120 may be a web server providing services corresponding to the push messaging server 104 or publisher 102, over the web. Server 1120 may provide data services over the web to mobile devices through a network 1115. Examples of clients that may access data via the system architecture include computing device 900, which may include any general purpose personal computer 1102, a tablet computing device 1104 and/or mobile computing device 1106 such as smart phones. Any of these devices may obtain content from the store 1116.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Referring generally to FIGS. 1-11, various advantages of the systems and methods disclosed herein for delivery of push messages are apparent. For example, one advantage of the system described herein is that a publisher does not need to create a separate application to send push messages to users, but rather can leverage a universal PEWB. A further advantage of push messages generally is that the publisher does not need to know the phone number or specific contact information associated with the device in order to send the user a message; the publisher need only know a unique code capable of identifying the user, regardless of whether that identification is sufficient to contact the user. A still further advantage of the system described herein is that push messages are routed to the user of the PEWB regardless of whether the user has installed an application of the publisher, whether the application changes or even whether the web domain or URLs of the publisher changes—in any and all cases the messages will get to the correct user of the PEWB so long as the PEWB remains installed on the user's device. This makes it significantly easier for publishers to send push messages. Furthermore, another advantage of the system described herein is that users can see all of their Push Messages in a single location, regardless of their source.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

We claim:

1. A system capable of coordinating push messages from among a plurality of sources, the system comprising:
a push message server communicatively connected to a plurality of publishers, the push message server including:
a push subscription database containing a plurality of records, each record associating a user identity with a push message publisher and a user preference for receiving push messages from the publisher;
a communication component configured to receive push messages from one or more of the plurality of publishers and, based on user subscriptions managed in the push subscription database, transmit the push messages to one or more subscribers.

2. The system of claim 1, wherein the push subscription database includes contact information for each of the one or more subscribers.

3. The system of claim 1, wherein the push message server is remote from each of the plurality of subscribers.

4. The system of claim 1, further comprising a push-enabled browser component installable at a subscriber device, wherein the push-enabled browser is configured to access information at one or more websites associated with the plurality of publishers and allow the subscriber to subscribe to push messages from one or more of the plurality of publishers.

5. The system of claim 4, wherein the push-enabled browser executes on a mobile device remote from the push message server.

6. The system of claim 5, wherein the push-enabled browser is capable of receiving push messages from the communication component of the push message server when the push-enabled browser is not running.

7. A method of distributing push messages to one or more users, the method comprising:
receiving at a push message server a push message and an identity of one or more intended recipients from a publisher;
checking the identity against a list of subscribed users to determine a list of one or more recipients of the push message; and
queuing the message for transmission to each of the one or more recipients.

8. The method of claim 7, further comprising transmitting the message to each of the one or more recipients.

9. The method of claim 7, further comprising receiving a subscription request associated with a user, the subscription request identifying a publisher from which the user wishes to receive push messages.

10. The method of claim 9, wherein receiving the subscription request comprises receiving a subscription request from a publisher, the subscription request further identifying a user associated with the subscription request.

11. The method of claim 7, further comprising, for each recipient, determining if a user device is active and, upon determining that the user device is active, transmitting the message to the recipient associated with that user device.

12. The method of claim 7, further comprising, for each recipient, determining if a user device is active and, upon determining that the user device is unavailable, maintaining the message in a push message queue for later transmission to the user device.

13. A method of sending push messages comprising:
receiving an indication from a user device at a publisher indicating an intent to subscribe to push messages associated with the publisher;
transmitting a subscription request to a push message server, the subscription request including information identifying the user, the publisher, and an intent to subscribe to push messages associated with the publisher;
transmitting a push message to the push message server alongside an identity of the user, thereby causing the push message server to transmit a push message to a push-enabled web browser of a user device.

14. The method of claim 13, wherein the user device is a mobile device.

15. The method of claim 13, wherein the information identifying the publisher includes domain information.

16. The method of claim 13, wherein the information identifying the publisher includes web page information.

17. The method of claim 13, wherein the information identifying the user includes a user identifier.

18. The method of claim 17, wherein the information identifying the user lacks user contact information.

19. The method of claim 13, further comprising storing at least some of the subscription request in a database at a push message server.

20. The method of claim 13, further comprising prompting a user to subscribe to push messages associated with the publisher prior to receiving the indication from the user device.

21. A method of receiving push messages comprising:
installing a push-enabled web browser at a mobile device;
visiting a web domain of a publisher;
taking one or more actions indicating a desire to subscribe to push messages associated with the publisher; and
at a later time, and after one or more push messages is transmitted from the publisher to a push message server, receiving a push message from the push message server that is originated from the publisher without transmitting a request to the push message server.
